(19) United States
(12) Patent Application Publication
(10) Pub. No.: US 2017/0232335 A1
(43) Pub. Date: Aug. 17, 2017

(54) PHYSICAL/VIRTUAL GAME SYSTEM AND METHODS FOR MANIPULATING VIRTUAL OBJECTS WITHIN A VIRTUAL GAME ENVIRONMENT

(71) Applicant: Prizm Labs, Inc., Los Angeles, CA (US)

(72) Inventors: Brandon L. Williams, Los Angeles, CA (US); Michael A. Garrido, Los Angeles, CA (US); Jimmy A. Chen, Los Angeles, CA (US)

(21) Appl. No.: 15/425,637

(22) Filed: Feb. 6, 2017

Related U.S. Application Data
(60) Provisional application No. 62/291,516, filed on Feb. 5, 2016.
(60) Provisional application No. 62/291,517, filed on Feb. 5, 2016.

(51) Int. Cl. A63F 13/235; A63F 13/5375; A63F 13/58; A63F 13/30

(52) U.S. Cl. CPC A63F 13/235; A63F 13/30; A63F 13/5375; A63F 13/58

(57) ABSTRACT

One variation of a method for manipulating virtual objects within a virtual game environment includes: at a game console, initializing a first virtual game environment in an instance of a first electronic game; rendering a prompt to link a physical gamepiece to a virtual object within the first electronic game; in response to placement of a physical object over the display of the game console at a first time, accessing an unique identifier from the physical object, confirming permission to link the physical object to the virtual object based on the unique identifier and a characteristic of the virtual object, and linking the unique identifier to the virtual object; and, at a second time, detecting placement of the physical object at a second position over the display and rendering a graphical representation of the virtual object on a second region of the display coinciding with the second position.

### CROSS-REFERENCE TO RELATED APPLICATIONS

This application claims the benefit of U.S. Provisional Application No. 62/291,516, filed on 5 Feb. 2016, and U.S. Provisional Application No. 62/291,517, filed on 5 Feb. 2016, both of which are incorporated in their entireties by this reference.

### TECHNICAL FIELD

This invention relates generally to the field of gaming systems and more specifically to a new and useful physical/virtual game system and methods for manipulating virtual objects within a virtual game environment in the field of gaming systems.

### BRIEF DESCRIPTION OF THE FIGURES

FIG. 1 is a flowchart representation of a first method;

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

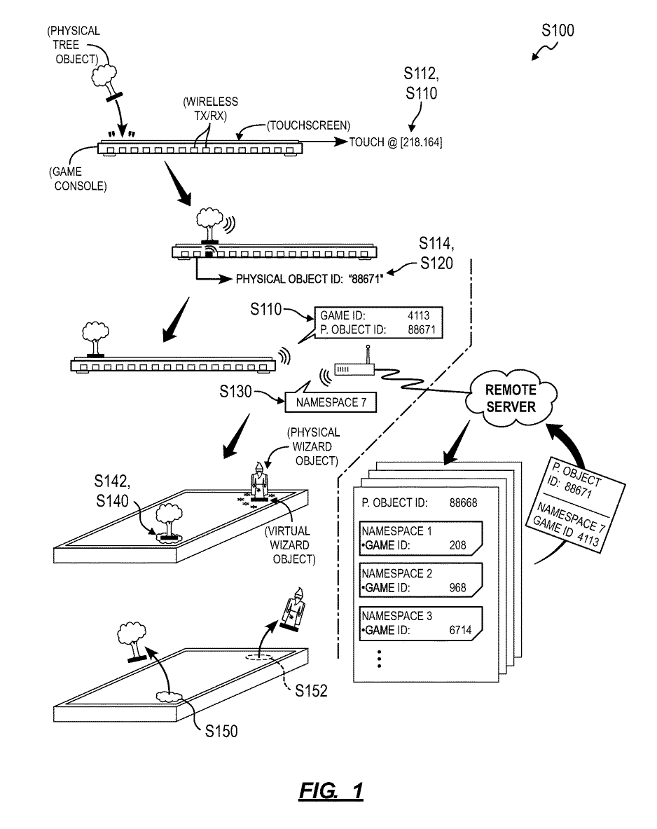

As shown in FIG. 1, a method S100 for accessing and manipulating virtual objects within a virtual game environment, includes: during an instance of a first electronic game in play at a game console, sampling a touch sensor coupled to a main display within the game console in Block S112; in response to detection of a physical object at a first position over the touch sensor, sampling a first wireless receiver, in an array of wireless receivers arranged in the game console, coinciding with the first position in Block S114; accessing a first graphical representation of a first virtual object associated with the first electronic game and linked to an unique identifier downloaded from the physical object via the wireless receiver in Block S130; and rendering the first graphical representation of the first virtual object on a first region of the main display coinciding with the first position in Block S140.

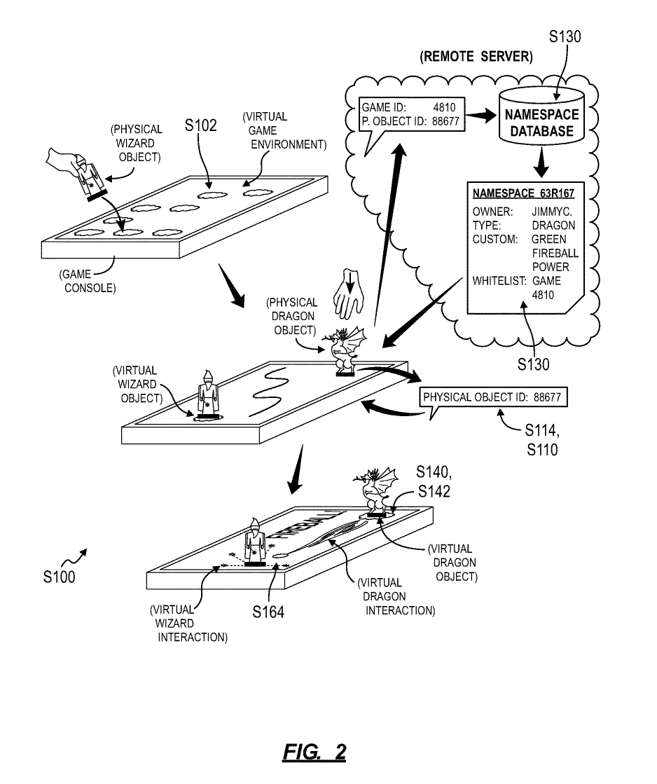

As shown in FIG. 2, one variation of the method S100 includes: at a game console, receiving a selection for a particular game from a set of games in Block S102; reading an ID of a physical object placed on the game console in Block S114; based on the ID of the physical object, identifying a set of namespaces assigned to the physical object in Block S130; selecting a particular namespace, from the set of namespaces, corresponding to the particular game in Block S130; during play of the particular game at the game console, constructing a virtual object within a virtual game environment according to virtual object definitions contained within the particular namespace in Block S130; and, in response to interactions between the physical object and the game console, manipulating the virtual object within the game environment according to virtual interaction rules defined in the particular namespace in Block S140.

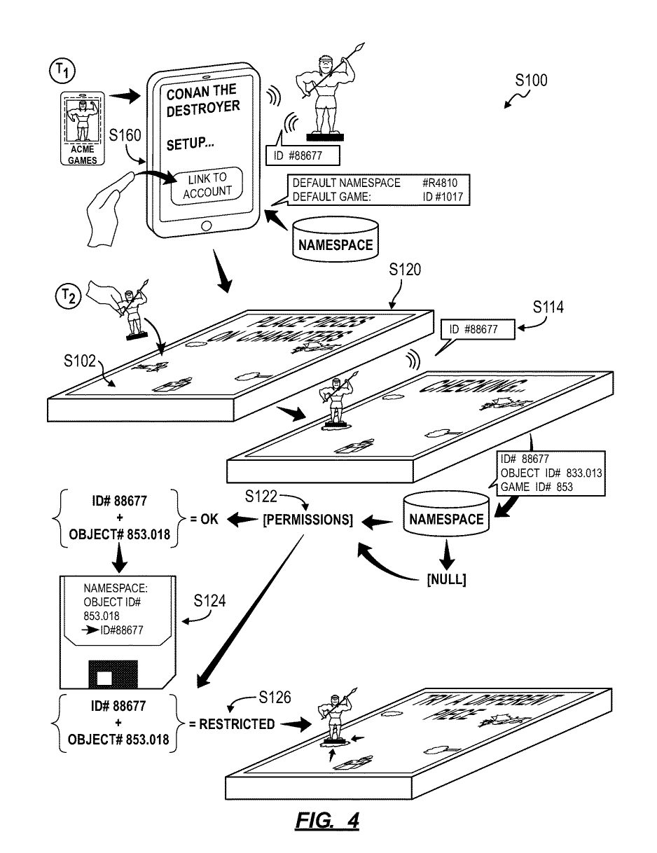

As shown in FIGS. 2 and 4, another variation of the method S100 includes: at a game console, initializing a first virtual game environment in an instance of a first electronic game in Block S102; rendering a prompt on a main display of the game console to link a physical gamepiece to a virtual object within the first electronic game in Block S120; in response to placement of a physical object over the main display of the game console at a first time, accessing a unique identifier from the physical object in Block S114, confirming permission to link the physical object to the virtual object based on the unique identifier and a characteristic of the virtual object in Block S122, and linking the unique identifier to the virtual object in Block S124; and, at a second time: detecting placement of the physical object at a second position over the main display in Block S110 and rendering a graphical representation of the virtual object on a second region of the main display coinciding with the second position in Block S140.

Yet another variation of the method S100 shown in FIGS. 2, 4, and 5 includes: linking a unique identifier encoded into a physical object to a first user account of a first user in Block S160; associating a first namespace with the unique identifier, the first namespace defining a characteristic of a first virtual object within a first electronic game in Block S162; initializing an instance of the first electronic game in Block S102; during the instance of the first electronic game in play at the game console, detecting presence of the physical object at a first position on the game console based on receipt of the unique identifier wirelessly broadcast from the physical object in Block S110; retrieving the first namespace in Block S130; generating a first graphical representation of the first virtual object according to the characteristic defined in the first namespace in Block S142; rendering the first graphical representation of the first virtual object on a first region of the main display coinciding with the first position in Block S140; and, in response to a gameplay action during the instance of the first electronic game, modifying the characteristic of the first virtual object defined in the first namespace in the first user account in Block S164.

### 2. Applications

Generally, the method S100 can be executed by a game console to display a virtual (e.g., “digital”) game environment of an electronic game, to identify a physical (e.g., “real”) object interacting with the game console in real space, to retrieve definitions of a virtual object specific (e.g., unique) to the combination of the physical object and the game, and to manipulate the virtual object within the virtual game environment based on these physical-object-specific definitions and based on physical interactions between the physical object and the game console.

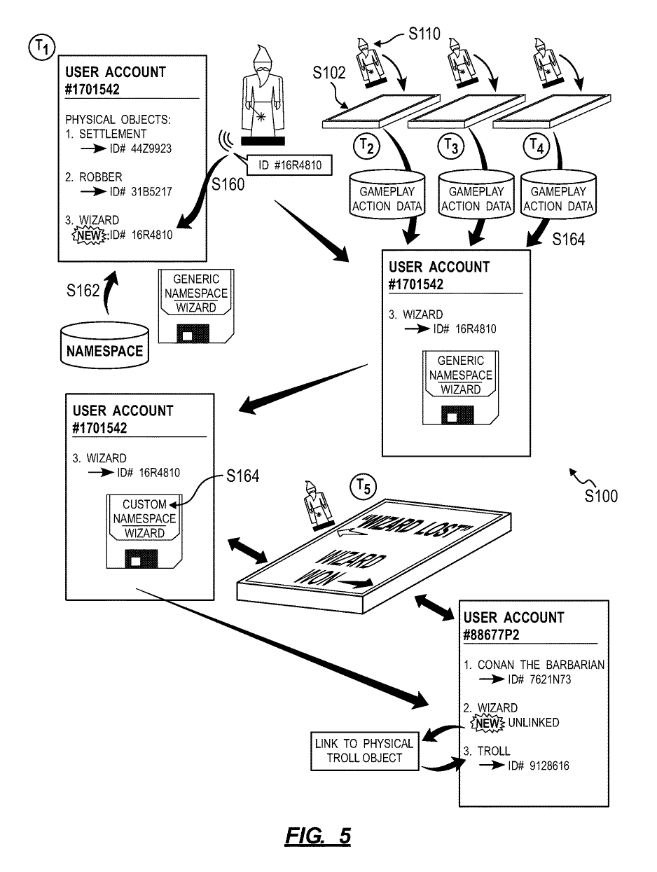

For example, the game console can include a touch sensor, a main display, and an ID scanner (e.g., a radio-frequency identification or “RFID” reader) that cooperate: to detect the presence and location of a physical object on a surface of the game console; to read an identifier (hereinafter an “ID”) from the physical object; to display a virtual game environment of a selected game; and to update the virtual game environment based on interactions between the physical object and the game console and between players (hereinafter “users”) and virtual objects rendered on the main display. In this example, the game console can also include: a wireless communication module that interfaces with a remote server via a computer network to download games selected at the game console and data from namespaces of physical objects placed on the game console's touchscreen; and a memory module that stores action, history, and interaction data, etc. of physical objects and corresponding virtual objects at the game console during gameplay and that cooperates with the wireless communication module to update namespaces with these action, history, and interaction data of their corresponding physical and virtual objects, as shown in FIG. 5.

The game console can execute the method S100 to: identify a physical object placed on (or otherwise physically interfacing with) the game console during a gameplay; to retrieve a namespace assigned to the physical object and corresponding to the particular game; to associate a virtual object within a virtual game environment of the particular game with the physical object; to define the appearance, actions, and/or interactions of the virtual object within the virtual game environment according to the namespace; and to update the namespace assigned to the physical object according to actions and interactions of the virtual object within the virtual game environment, as controlled by the physical object in real space. Thus, when this same physical object is later identified during execution of another instance of the same game at the same or other game console, this game console can retrieve this updated namespace and apply data from this updated namespace to another instance of the virtual object associated with the physical object, thereby enabling a user to customize or upgrade a virtual object associated with the physical object, enabling the user to control the virtual object at a game console through the physical object, and enabling the user to recall this customized or upgraded virtual object at a later instance of the game at the same or different game console by placing the same physical object on the game console.

Furthermore, a system—including the game console, a set of ID-enabled physical objects, and a set of namespaces assigned to these physical objects—can track activity and history of a physical object and its corresponding virtual object within a virtual game environment of a game, store these data remotely from the physical object, and access these data whenever the physical object is again used at the game console during a gameplay of the same game. During a gameplay of the same game at a second game console at a later time, the second game console can similarly: access this same namespace when the same physical object is placed on the second game console; and introduce and then control a corresponding virtual object within the virtual game environment of the gameplay according to this namespace linked to the physical object and according to interactions between the physical object and the second game console.

The physical object can be similarly linked to other namespaces unique to other games, and a game console can selectively retrieve and implement these game-specific namespaces when the game console identifies the physical object during gameplay of these other games. For example, the physical object defining an action figure can be: permanently linked, by default, to a first namespace corresponding to a virtual character exhibiting an appearance similar to that of the action figure and associated with a first game; permanently linked to a virtual token in a second game by the action figure's owner; and temporarily linked to a virtual environmental object (e.g., a tree, a settlement) in a third game to enable the action figure's owner to place such a virtual environmental object within the third game via the action figure when a physical environmental object—dedicated to the virtual environmental object—is not physically available at the game console. The physical object can therefore be linked—by its unique ID—to multiple namespaces for various virtual objects, each unique to an electronic game that can be accessed and played at the game console.

Because the system stores namespaces remotely from the physical object, a namespace assigned to a physical object can persist even after the physical object is lost, broken, or replaced by another physical object. The system can also reassign a namespace to another physical object, such as if an original physical object is lost and replaced with another physical object, such as if the original physical object is upgraded to another physical object (e.g., from a plastic object to a pewter object), or such as if a virtual object linked to the original physical object via the namespace is won or captured by an other user during a gameplay and reassigned by the other user to another ID-enabled physical object owned by the other user.

Therefore, the system can: network physical objects; store namespaces and other data specific (or unique) to physical objects in a backend database remote from the physical objects; and retrieve, distribute, and update data from these namespaces as physical objects are interfaced with game consoles during gameplays over time.

### 3. Game Console

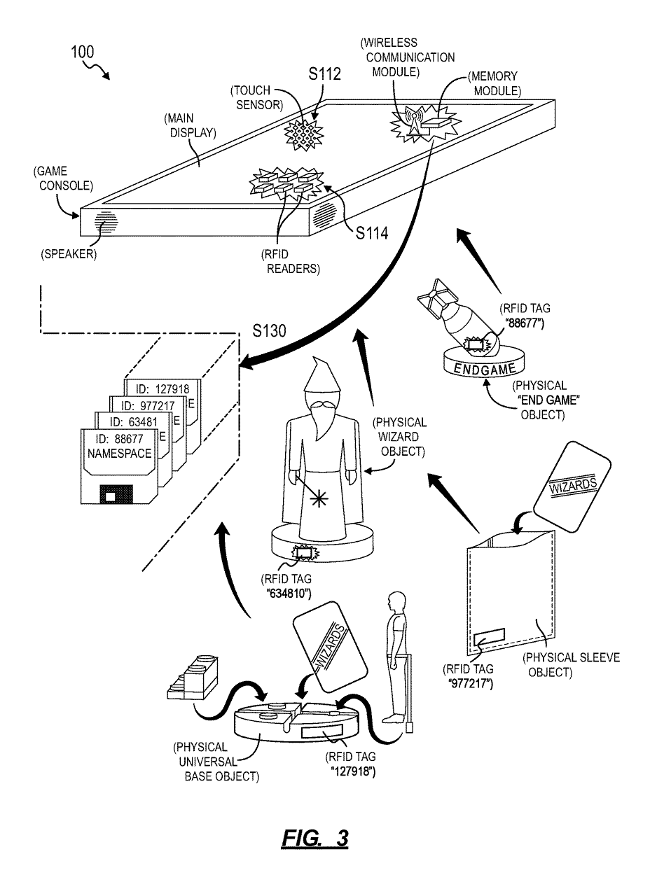

As shown in FIG. 3, a game system includes: a physical object including an unique identifier (“ID”); a first namespace uniquely linked to the unique ID, associated with a first game, and including visual definitions of a first virtual object represented by the physical object and rules for interaction of the first virtual object within a virtual game environment of the first game; a second namespace uniquely linked to the unique ID, associated with a second game, and including definitions of a second virtual object associated with the second game; and a game console configured: to collect the unique ID from the physical object, to display the first game environment of the first game, to access the first namespace from a set of namespaces including the first and second namespaces in response to receipt of the unique ID during display of the first virtual game environment, and to manipulate the first virtual object within the first virtual game environment based on physical interactions between the physical object and the game console.

As shown in FIG. 3, the game console can include: a main display; a wireless communication module configured to transmit and receive game, gameplay, and namespace data with a remote server; a memory module; a touch sensor configured to detect instances and locations of objects contacting a surface of the game console (e.g., a surface over the main display); and a set of wireless receivers configured to wirelessly read IDs from nearby physical objects.

In one example, the array of wireless receivers can include: a set of RFID transmitter and receiver pairs patterned under the main display in a grid array at density of one antenna per four square inches; and the touch sensor can include a capacitive touch sensor integrated into (or arranged over or below) the main display. In this example, the array of wireless receivers can include an array of antennae in a cross-hatch pattern, including rows of antennae in a first layer and columns of antennae in a second layer offset from the first layer; and the main display can be interposed between the array of wireless receivers and the touch sensor. The game console can regularly sample the touch sensor for a new contact by a physical object, such as at a rate of 20 Hz, in Block S112. When a new contact is detected at a particular location over the touch sensor, the game console can: trigger a wireless transmitter adjacent the particular location to broadcast a power signal (e.g., over a period of 50 milliseconds); and sample a particular wireless receiver paired with this wireless transmitter for receipt of a unique ID from a physical object that may have been placed over the display at the particular location in Block S114. Upon receipt of a unique ID from the physical object via the particular wireless receiver, the game console can compare this unique ID to a current list of IDs and locations of physical objects previously detected on the main display. If the unique ID is not contained in the current list of IDs and was not previously placed on the game console during the current gaming session, the game console can: download a namespace linked to the unique ID and associated with the game currently in process on the game console, such from a remote database, and store this namespace in local memory for the duration of the current gaming session; enter a virtual object linked to the unique ID via the namespace into the virtual game environment; generate a custom graphical representation of the virtual object if the namespace defines unique or custom visual attributes for the virtual object or retrieve a generic graphical representation of the virtual object, such as a static graphical asset from the media contained in the current game; render the graphical representation of the virtual object—substantially centered over the particular position of the physical object detected by the touch sensor—on the display; and update a virtual game environment of the current game according to a gameplay action associated with the virtual object or configured by a player before placing the physical object on the game console. However, if the unique ID is not contained in the current list of IDs but was previously placed on the game console during the current gaming session, the game console can implement a similar process to render the graphical representation of the virtual object linked to the unique ID of the physical object via the namespace stored locally on the game console. Furthermore, if the unique ID is contained in the current list of IDs but at a different location on the game console, the game console can update the location of the graphical representation rendered on the display according to the new position of the physical object and update the virtual game environment according to this move.

The game console can therefore confirm presence of a new physical object and update the virtual game environment and content rendered on the display accordingly; the game console can then update the current list of physical object IDs and their locations with new IDs and/or new locations of physical objects. The game console can also regularly sample all or select wireless receivers for unique IDs of physical objects previously detected on the game console; when a unique ID contained in a current list of physical object IDs and locations is not received during such a scan cycle, the game console can: remove this unique ID from the current list of physical object IDs and locations; and update the virtual game environment rendered on the display according to the type or class of the virtual object linked to the physical object. For example, if the virtual object defines a character, the game console can remove the virtual object from the virtual game environment when the associated physical object is removed from the game console in Block S152; however, if the virtual object defines a virtual environmental object, such as a river element or settlement element, the game console can preserve the virtual object within the virtual game environment when the associated physical object is removed from the game console in Block S150.

In a similar implementation, the game console includes: an array of wireless transmitters spanning the display and configured to broadcast a power signal to excite RFID tags in physical objects placed across the full width and length of the display; and an array of wireless receivers patterned across (e.g., under) the display, each configured to read unique IDs broadcast from physical objects placed nearby (e.g., within three inches) of the wireless receiver. When physical contact over the display is detected at a particular position by the touch sensor, the game console can: trigger the wireless transmitters to broadcast a power signal; and sample a particular wireless receiver adjacent the particular position for a wireless ID broadcast by an adjacent physical object. However, the game console can include any other number or configuration of wireless transmitters and receivers or any other sensor(s) in any other quantity configured to collect identifying data from physical objects placed on or near the game console.

### 3. ID-Enabled Physical Object

The game console can execute various games, such as abstract games, chess variants, economic simulation games, fantasy games, position games, race games, roll-and-move games, territory games, tile-based games, themed games, wargames, and/or games of any other type. A physical object can therefore define a physical representation of: a virtual character (a superhero, dragon, witch, wizard, or dinosaur, etc); a virtual token; a virtual upgrade (e.g., virtual manna, health, armor, a virtual weapon, or a power, etc.); a virtual resource (e.g., virtual bricks, lumber, or train cars, etc.); a virtual environment element (e.g., a virtual tree, snow, or body of water, etc.); a virtual macro game control (e.g., a physical object in the form of a bomb that, when placed on the main display of a game console during a game, ends the game and returns the game console to a home screen); a virtual die; or any other virtual object within a virtual game environment. The physical object can also represent other similar or dissimilar virtual objects in other virtual game environments of other games, such as defined in other namespaces uniquely assigned to the physical object and associated with these other games, as described below.

### 3.1 Unique IDs

A physical object can define a physical structure, such as an injection molded (and screen-printed) rigid or flexible polymer structure in the form of a default or primary virtual character, token, upgrade, or environmental element, etc. that the physical object represents or is linked to in a default or primary virtual game environment. Alternatively, the physical object can include: a 3D-printed structure; a cast (e.g., diecast), stamped, or machined metal (e.g., pewter, aluminum) structure; a structure hand-formed from a modeling compound; a paper or plastic game card; a slip-molded ceramic structure; or a structure of any other suitable material or form.

The physical object is also encoded with an identifier (or “ID”) that can be read by a game console. In one implementation, the physical object includes a passive radio-frequency identification (“RFID”) tag encoded with a substantially unique ID (e.g., a universally unique identifier, or “UUID”) and configured to broadcast the ID in response to receipt of a power signal and interrogating signal from an RFID reader in a game console, as shown in FIGS. 1, 2, and 3. The physical object is described herein as including a passive RFID tag, and the game console is described herein as including an RFID reader configured to read IDs from RFID tags in physical objects placed on and/or near the game console.

However, the physical object can be encoded with an ID of any other type. For example, the physical object can include a base defining three contact points in unique relative positions; a game console can thus detect contact points of a physical object placed on its main display, transform the relative positions of these contact points into an ID value (or “fingerprint”), and retrieve a namespace for the physical object based on this ID value. In another example, a substantially unique alphanumeric sequence or a 1D or 2D barcode encoded with a substantially unique ID can be printed on or otherwise applied to the bottom of the physical object; a game console can include pixel sensors (e.g., CCD pixels, active CMOS sensors) integrated into the main display and configured to read an alphanumeric sequence of barcode from the bottom of a physical object placed on the main display. In yet another example, the bottom surface of the physical object features a unique pattern of metal-plated recesses; when the physical object is placed over the main display, the capacitive touch sensor reads a set of (relative) capacitance values from the unique pattern of recesses, and the game console translates this set of capacitance values into a unique ID of the physical object. In another example, the physical object can include an active RFID tag, a short-range wireless radio, or other wireless communication module encoded with an ID and configured to broadcast the ID in response to receipt of a request from a game console.

### 3.2 Custom Physical Objects

In one implementation, the system includes generic bases, generic ID tags (e.g., RFID-enabled stickers), or generic ID-enabled card sleeves configured to form an assembly with an external physical object (e.g., a physical object not originally affiliated with the system or a game or virtual game environment executed by the system, such as a “dumb” action figure or toy car) and to link the external physical object to a virtual object within a virtual game environment of a game via an ID encoded into the generic base, ID tags, or card sleeve.

In one example, the system includes a translucent polymer sleeve configured to receive a playing card and including an embedded RFID tag, as shown in FIG. 3. In this example, a user can insert a playing card into the translucent polymer sleeve and then access the native object portal application through her smartphone to link the ID in the translucent polymer sleeve—now containing the playing card—to a virtual object, such as described below. In a similar example, the system can include an RFID-enabled sticker; in this example, a user can apply the RFID-enabled sticker to an action figure or other external physical object and then access the native object portal application through her smartphone to link the ID in the RFID-enabled sticker to a virtual object, such as described below.

In yet another example, the system includes a generic ID-enabled base configured to accept one or more external physical objects, as shown in FIG. 3. In this example, the universal RFID-enabled base can define a three-dimensional round or polygonal base structure containing an RFID tag sealed inside. The base structure can also include: a set of studs extending from the top surface of the base and configured to interface with interlocking plastic construction bricks; a first linear slot of a first width passing across the full width of the top of the base at a depth less than the height of the base and configured to receive a thick playing card; a second linear slot of a second width less than the first width, passing across the full width of the top of the base at a depth less than the height of the base, and configured to receive a thin playing card (wherein the second linear slot is parallel to and offset from the first slot or is perpendicular to the first slot); and/or a bore passing through the base, aligned with the axis of the base, terminating in a counterbore on the underside of the base, and configured to receive a threaded fastener to mechanically fasten a toy car to the top of the base. In this example, the base structure can additionally or alternatively include a blind bore in the top of the base, offset from the axis of the base, and configured to receive a post; and the universal RFID-enabled base can further include a post configured to engage the blind bore in the base at a first end and including a set of tongs, a strap, or other feature at an opposite end, the engagement feature configured to engage a torso of an action figure and to support the action figure over the base. A user may thus transiently install an external object—not otherwise associated with a game or not otherwise configured to interface with a virtual environment through the game console—onto a universal base in order to enable use of the external object within a virtual game executed on the game console. The user may therefore install any one or various external physical objects onto the universal RFID-enabled base and then interface with a game console or native object portal application to link the universal RFID-enabled base to a virtual object.

### 4. Namespaces

The physical object's unique ID is linked to one or more namespaces for one or more electronic games. Generally, an ID encoded into the physical object is intransiently (e.g., permanently) or temporarily linked to a namespace defining static and/or dynamic attributes of a virtual object (e.g., the virtual object's appearance and available functions assigned to the virtual object), how the virtual object interfaces with a virtual game environment within an instance of a game executed on a game console responsive to physical interactions between the physical object and the game console, and how the virtual object interfaces with other virtual objects within its corresponding virtual game environment.

One physical object can therefore selectively control multiple virtual objects (or “avatars”) across multiple games played across multiple game consoles over time. In particular, a player (e.g., the physical object's owner) can control a first virtual object within it's virtual game environments rendered on a display at a first game console or trigger a gameplay action available to the first virtual object within its virtual game environment by placing the physical object onto the first game console or by moving the physical object across the first game console during an instance of the first game; in this example, the first game console can automatically retrieve a first namespace linking the physical object's unique ID to the first virtual object when the physical object is placed on the first game console during an instance of the first game and control the first virtual object within its virtual game environment during the instance of the first game according to interaction rules defined in this first namespace. Later, the player can control a second virtual object within its virtual game environment rendered on a display at a second game console or trigger a gameplay action available to the second virtual object within its virtual game environment by placing the physical object onto the second game console or by moving the physical object across the second game console during an instance of the second game; in this example, the second game console can similarly retrieve a second namespace linking the physical object's unique ID to the second virtual object automatically when the physical object is placed on the second game console during an instance of the second game and control the second virtual object within its virtual game environment during the instance of the second game according to interaction rules defined in this second namespace.

Therefore, by linking multiple namespaces to one physical object's unique ID, the system can enable players to interact within multiple unique virtual objects across multiple unique games played over time through a single ID-enabled physical object. The system also maintains and updates select namespaces linked to the physical object over time, as shown in FIG. 1 and described below. By storing associations between a physical object's unique ID and a physical object remotely from the physical object and the game console, the physical object's owner can access namespaces associated with the physical object at any game console by placing the physical object on an (Internet-connected) game console. Also, if the physical object's owner prepares to play an instance of an electronic game at a game console but has lost her physical object or not brought her physical object with her, the system can temporarily reassign a corresponding namespace to a second ID-enabled physical object to which the player does have access, thereby enabling the player to enter and manipulate her virtual object (e.g., a custom character or avatar) within the game despite not having the physical object originally linked to this virtual object. Furthermore, the system can reallocate a namespace from a first physical object to a second physical object, such as if the owner of the first physical object loses or trades a namespace associated with the first physical object to an owner of the second physical object, as described below.

### 4.1 Namespace Content

A namespace contains various static and/or dynamic namespaces relating to a virtual object. In one implementation, a namespace specifies a type of a virtual object (e.g., an “object profile”) represented by the physical object within a particular game. For example, the namespace can specify whether the physical object represents a character, an upgrade, a resource, an environment object, or a macro game control, etc. which can link to generic definitions for interactions of such virtual object types within a corresponding virtual game environment.

The namespace can also define a position of the virtual object—corresponding to the physical object—within a hierarchy of objects within the virtual game environment. For example, for a namespace that specifies a virtual tree object (an environment-type virtual object), the namespace can define the virtual tree object below a virtual snow object and above a virtual ground object such that, when the physical object is placed on the main display of a game console, the game console can update the main display to show a virtual tree at a position coinciding with the location of a physical object on the main display and over a virtual ground area according to this hierarchy specified in the namespace. Similarly, when a second physical object representing a virtual snow object is later placed on the main display of the game console, the game console can update the main display to show virtual snow over the virtual ground and patterned over branches of the virtual tree according to this hierarchy in the namespace.

The namespace can also contain digital media for the virtual object represented by the physical object within a virtual game environment. For example, the namespace can contain generic static images, generic animations, visual overlays (e.g., representing virtual upgrades to the virtual object), audio content, and/or textual descriptions, etc. for the virtual object. Thus, when the physical object is placed on a main display during a gameplay of the corresponding game at the game console, the game console can retrieve these media from the namespace, render visual content on the main display, and/or replay audio content through an integrated or peripheral speaker. Furthermore, the namespace can contain rules for customization of the virtual object represented by the physical object in the corresponding game. For example, the namespace for a virtual character can include: customization rules identifying customizable virtual surfaces of the virtual character and specifying available colors for these customizable virtual surfaces; and customization rules for types and combinations of weapons and powers that can be added to the virtual character.

Alternatively, the namespace corresponding to a particular game and assigned to a particular physical object via the physical object's unique ID can contain pointers to any of the foregoing generic data. For example, the namespace can include pointers to data standard to a game, stored in a remote database, and downloaded to a game console each time the game is selected for play at the game console. In another example, the namespace can include points to such data contained in game files downloaded to a game console and stored locally at the game console when the game is purchased.

### 4.2 Dynamic Namespace

The namespace can also record dynamic, object-specific data. In one implementation, the namespace includes an ownership history of the physical object and/or the namespace, such as including an identifier of current and past owners and instances of ownership transfer, such as via purchase, trade, win, or loss of the physical object and the physical object uniquely defined by the namespace, as shown in FIG. 5. The namespace can also contain customization settings for the virtual object, such as avatar settings and won or purchased upgrades loaded into the corresponding virtual character. The namespace can further contain activity data of the virtual object, such as: a legend of modifications, upgrades, downgrades, etc. to the virtual object during gameplays at one or more game consoles—with the corresponding physical object—over time; points awarded to or lost by the virtual object; a last health score of the virtual object; a current level of the virtual object; a list of powers available to the virtual object; etc. Similarly, the namespace can contain a history of the physical object (e.g., use of the physical object—according to the namespace—at one or more game consoles). For example, the namespace can contain: a timeline of game consoles at which the physical object has been used; identifiers of gameplays of the corresponding game in which the physical object has been used; a list of IDs of other physical objects that have been used with the physical object during gameplays of the game; and a list of IDs of users who have played the physical object during a gameplay and been present when the physical object was played during a gameplay; etc. Therefore, a namespace assigned to a physical object and associated with a particular game can define a single linear story of the physical object and its virtual counterpart within instances of this game—including the history, activity, and context of the physical object physically interfacing with game consoles and the history, gameplay actions, and context of the virtual object within the virtual game environment during instances of the particular game—played over time at one or more game consoles.

Generally, a physical object's unique ID can be associated with one or more static namespaces and/or one or more dynamic namespaces for various electronic games accessible through a game console. While a static namespace contains fixed data—such as a fixed data associated with a virtual object, a fixed definition for a graphical representation of the virtual object, and a fixed function or action of the virtual object when introduced into a virtual game environment via placement of the physical object on a game console—a dynamic namespace can be modified over time by various game consoles as the virtual object is controlled within various instances of a corresponding electronic game over time via one associated physical object. For example, the game console or native object portal application (described below) can record upgrades, downgrades, and customization options entered by an owner of the physical object to the namespace; when later called by a game console, the namespace can inform local reconstruction of a graphical representation of the custom virtual object and a custom set of functions or actions available to the virtual object when manipulated within the virtual game environment through interactions between the physical object and the game console. Similarly, the game console or native object portal application can record changes in the strength or health status of, upleveling or achievements made by, and/or other gameplay actions involving the virtual object to the namespace during an instance of the electronic game. During a later instance of the electronic game in which the same physical object is introduced to the same or other game console, the game console can retrieve this updated namespace and manipulate data contained in this updated namespace to set a level, available controls, available actions, and/or other parameters of the virtual object for this next instance of the game. The dynamic namespace can therefore preserve custom data and a history of a virtual object linked to a physical object played in various instances of a corresponding game at various game consoles over time.

### 4.3 Original Namespace

By default, a physical object can be associated with a default namespace defining a primary virtual object. For example, when a physical object is manufactured, an ID can be loaded onto the physical object, such as by writing an unique ID (e.g., a UUID) to a wireless transmitter integrated into the physical object or by inserting and sealing a wireless transmitter preloaded with a unique ID (e.g., an RFID tag) within the physical object. An available namespace—stored in a remote database accessible via a computer network (e.g., the Internet) and defining a default virtual object affiliated with the physical object—can then be associated with the physical object by linking the new physical object's ID to the namespace, such as within a name mapping system or by writing the new physical object's ID directly to the selected namespace.

In one example in which the physical object defines a physical character token for a first game, the physical object's unique ID can be linked by default to a first namespace associated with the first game and defining visual attributes and interaction modes of a virtual character token exhibiting an appearance similar to the physical object. Over time, the physical object's owner can customize, upgrade, or otherwise modify the appearance of the virtual character token while the physical object remains unchanged; these changes can be stored in the first namespace and implemented in each instance of the first game in which the physical object is introduced at a game console.

### 4.4 Additional Namespace

The physical object can be linked to additional namespaces for other virtual objects in other electronic games. In particular, one physical object can represent different virtual objects within different virtual game environments over time. For example, the physical object's unique ID can be linked to a: default namespace for a default virtual object in a default electronic game according to a default setting defined by a publisher of the default electronic game; and one namespace for each virtual object linked to the physical object for other electronics games played with the physical object, such as described below and shown in FIG. 1.

In one implementation, for each game in which the physical object is authorized for use and/or is used over time, the system generates a namespace and assigns the namespace to the physical object's unique ID, wherein each namespace includes a set of static object data defining rules for interactions of a virtual object within a corresponding virtual game environment based on real interactions between the physical object and a game console.

The physical object's ID can also be associated with a set of user permissions. In one implementation, a brand or publisher of a game containing a virtual object represented by the physical object can define a blacklist specifying: a second game for which virtual objects in the second game are not permitted to be linked to the physical object; specific virtual objects in published games not permitted to be linked to the physical object; and types and/or characteristics of virtual objects with which the physical object is not permitted to be linked; etc. The system can thus enable the physical object's owner to temporarily (e.g., during a single instance of a game) or permanently (e.g., across multiple instances of a game across multiple game consoles) link the physical object to a virtual object if the virtual object is ascribed attributes not represented in the blacklist. For example, a physical object of a physical form representing a superhero character and associated with a virtual superhero can be assigned a blacklist that rejects pairing the physical superhero object with a virtual goblin character or with a virtual resource object, such as a virtual tree, virtual snow, a virtual mountain, or a virtual body of water within a virtual game environment by the same publisher or by another publisher.

In another implementation, a brand or publisher of a game containing a virtual object represented by the physical object can define a whitelist specifying: other brands or publishers of games for which virtual objects in these games are permitted to be linked to the physical object; specific virtual objects in other games permitted to be linked to the physical object; characteristics of other virtual objects permitted to be linked to the physical object; and/or permitted durations of links between the physical object and such virtual objects, as shown in FIG. 2. The system can thus enable the physical object's owner to temporarily or permanently link the physical object to a virtual object if the virtual object is ascribed attributes represented in the whitelist.

A game console, instances of a native object portal application executing on a personal computing device (described below), and a remote server, etc. can therefore cooperate to maintain existing namespaces and to assign new namespaces to the physical object's unique ID over time according to a whitelist and/or a blacklist, such as described below.

### 4.5 Permanent and Temporary Namespaces

The physical object's unique ID can be linked to a persistent namespace that defines a (semi-) permanent link between the physical object and a virtual object such that this virtual object is called at any instance of the associated game at any game console over time when the physical object is placed on a game console executing this game. For example, the default namespace linking the physical object to a default virtual object can define a persistent namespace.

The physical object's unique ID can also be linked to a temporary namespace that defines a transient link between the physical object and a virtual object such that this virtual object is called only during one or a limited number of instances of the associated game when the physical object is placed on a game console executing this game. For example, the system can temporarily link the physical object to a virtual object: if another physical object linked to this virtual object by default is lost or missing; or if the physical object's owner is trialing a new game at a game console and does not yet have access to a physical object linked by default to this virtual object in this new game (e.g., before the physical object's owner purchases the new game and orders a kit of physical pieces specific to the new game).

### 5. Physical Object Activation

As shown in FIG. 4, Block S160 of the method S100 recites linking a unique identifier encoded into a physical object to a first user account of a first user; and Block S162 of the method S100 recites associating a first namespace with the unique identifier, the first namespace defining a characteristic of a first virtual object within a first electronic game. Generally, in Blocks S160 and S162, the system links the physical object to its owner's account and to a namespace (e.g., a default namespace for a default virtual object in a default link).

In one implementation, upon receipt of a (new) physical object, a user can register the physical object with his game account, such as through his personal mobile computing device (e.g., a smartphone, a tablet) executing a game-publisher-branded or general native object portal application. In one example, a user: receives an ID-enabled physical object for her birthday; opens a native object portal application on her personal smartphone; logs in to her personal account within the native object portal application; and then taps the physical object on the smartphone to access data for the physical object and customization features for a virtual object corresponding to the physical object in one or more namespaces. (Alternatively, the smartphone can automatically open the native object portal application in response to receipt of an ID and/or other value from the physical object.) In the example, when the physical object is tapped on or otherwise brought within wireless communication range of the user's smartphone, the native object portal application can interface with a wireless receiver (e.g., an RFID antenna and reader) integrated into the smartphone (or integrated into a peripheral device connected to the smartphone) to collect the ID from the physical object. The native object portal application can then pass the ID and an object availability request to a remote server, which can pass the physical object's unique ID into a DNS or other name mapping system to retrieve an ownership history of the physical object via the physical object's unique ID. The remote server can write a new ownership of the physical object, linking the physical object's unique ID to the user's game ID, to a general file for the physical object's unique ID or to each namespace associated with the physical object's unique ID, such as in response to subsequent submission of an access code by the user into the native object portal application.

Alternatively, for a physical object previously assigned to a second user and later gifted to or won by the user, the remote server can transmit a prompt to the second user to confirm that the physical object was gifted to the user or access game history of the physical object to confirm that the physical object was legitimately won by the user before writing a new ownership to a file or namespace for the physical object linking the user's ID to the physical object's unique ID. The smartphone and the remote server can therefore cooperate to confirm and record ownership of the physical object upon its first scan at a computing device executing a native object portal application linked to the user's account.

During a first session and during later sessions at the native object portal application for which the physical object is present at the user's smartphone, the native object portal application can also display a virtual object associated with the physical object's unique ID and can enable the user to customize this virtual object. For example, once ownership of the physical object by the user is confirmed (e.g., via an association between the user's profile and the physical object's unique ID): the native object portal application can transmit a request for games currently authorized for play with the physical object to the remote server; the remote database can access game IDs, titles, descriptions, and/or media for one or more such authorized games and can return these game data to the user's smartphone; and the native object portal application can then render—on its integrated display—images and/or descriptions of these authorized games and can prompt the user to select a particular game from the set. In response to selection of a particular game from this set by the user: the native object portal application can transmit a request to the remote server for a particular namespace assigned to the physical object's ID and corresponding to the particular game selected by the user; the remote server can retrieve and upload the particular namespace in part or in whole to the user's smartphone; and the native object portal application can extract various media (e.g., static images, animations, audio, and/or a textual description for a virtual object) from the particular namespace and present these data to the user through its display.

In another example in which the physical object is associated with a single game only or with a primary or default game, the native object portal application can: retrieve a namespace linked to the physical object's unique ID and corresponding to the single, primary, or default game; extract media from this namespace; and present these media on its display automatically following receipt of the ID from the physical object and confirmation of ownership of the physical object by the user. The native object portal application can therefore present audible and/or visual media of a virtual object corresponding to the physical objects for a particular game substantially in real-time in response to communication between the physical object and a computing device executing an instance of the native object portal application.

The native object portal application can then enable the user to customize the virtual object for the selected game. For example, the native object portal application can enable the user to alter a color (e.g., eye color, hair color), a size, a facial expression, clothing, a weapon, a shield, a symbol, a name, and/or other visual attributes of the virtual object. In another example, the native object portal application can present available upgrades—such as armor, health, strength, or powers—for the virtual object and enable the user to purchase these upgrades for the virtual object directly through the native object portal application. The native object portal application can then write values defining such customization of the virtual object to the namespace associated with the game and linked to the physical object's unique ID. When the physical object is later scanned at the same smartphone, at another computing device, or at a game console, etc. the virtual object can be reconstructed and can interface with a virtual game environment according to these customization values stored in this namespace.

### 6. Game Initialization and Gameplay

Block S102 of the method S100 recites, at a game console, initializing a first virtual game environment in an instance of a first electronic game. Generally, in Block S102, a game console initializes an instance of a selected game in preparation for local play by one or more players.

As shown in FIG. 2, to execute a gameplay of a game, the game console can: receive a selection for a particular game from a set of games in Block S102, such as by rendering a virtual library of free and/or purchased games currently available at the game console on the main display and receiving a selection for a particular game from the library. The game console can then retrieve—from local memory or from a remote database—game data, such as including audible and visual media, virtual objects, a virtual game environment, a rule set, and definitions for interactions between virtual objects and the virtual game environment, etc. for the selected game. The game console can automatically setup the virtual game environment for the gameplay, such as based on a number of players at the game console, and can initiate the gameplay accordingly. For example, when a physical object linked to an account of a particular player is placed on the game console at the start of a game, the game console can download a unique ID from the physical object in Block S114, retrieve a namespace linked to the unique ID and associated with the game in Block S130, identify the particular player (e.g., the given name or username of the particular player) from ownership data stored in the namespace, and automatically welcome the particular player at the game console and introduce the corresponding virtual object into the virtual game environment on the game console accordingly; the game console can repeat this process for each other physical object placed on the game console during setup of the game.

### 7. Physical Object Detection and Identification

As players place physical objects on the main display in order to control or modify associated virtual objects (or the virtual game environment) throughout the gameplay, the game console can: read an ID from a physical object placed on the game console in Block S114, such as according to the method S100 described below; and pass the physical object's unique ID and an ID of the game in process to a remote server. The remote server can then: identify a set of namespaces assigned to the physical object in Block S130; retrieve a particular namespace—in the set of namespaces associated with the physical object's unique ID—corresponding to the selected game in Block S130; and then return the particular namespace or data from the particular namespace to the game console. Before and/or during the gameplay at the game console, the game console can construct a virtual object, customize the virtual object, and/or define interactions within the virtual game environment according to virtual object definitions contained within the particular namespace in Block S130. In particular, when a physical object is placed on, hovered over, or moved across the main display (or on another surface of the game console), the game console can execute Blocks of the method S100 to detect presence of the physical object, to retrieve the physical object's unique ID, and to update the virtual game environment rendered on the main display accordingly.

One variation of the method S100 includes: during an instance of an electronic game in play at the game console, sampling a touch sensor coupled to the main display within the game console in Block S112; in response to detection of physical contact (e.g., by a physical gamepiece) at a first time at a particular position over the touch sensor, sampling a first wireless receiver, in an array of wireless receivers arranged in the game console, coinciding with the first position in Block S114; detecting placement of a physical object at the particular position in response to receipt of a unique ID from the physical object within a threshold duration following the first time in Block S110; and retrieving a namespace—linked to the unique ID and associated with the electronic game—in Block S130.

In one implementation, during operation, the game console regularly samples a touch sensor (e.g., a capacitive, resistive, acoustic, or optical touch sensor or sensor of any other type) coupled to the main display of the game console in Block S112, such as at a rate of 30 Hz. In response to detection of physical contact (e.g., by a physical gamepiece) at a particular location over the touch sensor, the game console: triggers a particular wireless transmitter—adjacent (e.g., below) the particular location on the touch sensor—to broadcast a power signal of sufficient strength to excite an RFID tag within an limited distance (e.g., three inches) to broadcast its unique ID; and samples a particular wireless receiver (e.g., an RFID reader)—paired with and adjacent the particular wireless transmitter—for receipt of a unique ID from an adjacent physical object in Block S114. Upon receipt of a unique ID at the wireless receiver within a threshold duration (e.g., 50 milliseconds) from transmission of the power signal by the wireless transmitter, the game console can: confirm that the unique ID was not previously placed on the game console during the current instance of a game in play at the game console or during a current session at the game console; and query a name mapping system for a namespace associated with an ID of the electronic game and the unique ID received by the particular wireless receiver via an Internet connection in Block S130. The name mapping system can return a corresponding namespace (or data extracted from this namespace) to the game console, and the namespace can store a copy of this namespace (or these select data) locally in memory for the duration of the current game or session. Alternatively, if the physical object's unique ID was previously received by a wireless receiver in the game console during the current game or session and a copy of the corresponding namespace is already stored locally on the game console, the game console can access this local copy of the namespace in Block S130.

Alternatively, the game console can regularly trigger the wireless transmitters to broadcast power signals and regularly scan the set of wireless receivers (e.g., a set of sixty RFID readers) for IDs of physical objects recently placed over the main display. In this implementation, the game console can estimate the position of a physical object currently in contact with the main display based on the position of a wireless receiver that collected an ID from the physical object, based on the position of a wireless receiver that received the ID from the physical object with the greatest signal strength among the set of wireless receivers, or by triangulating the position of the physical object based on positions of wireless receivers that received signals from the physical object and the strengths of these signals, etc. Alternatively, in response to receipt of a new physical object ID by a wireless receiver, the game console can scan the touch sensor for locations of objects in contact with the main display and compare these contact locations with contact locations recorded during a previous scan of the touch sensor to identify the position of a physical object recently placed on the main display. However, the game console can implement any other methods or techniques to detect placement of a physical object on the main display, to determine a location of the physical object on the main display, and to identify the physical object. The game console can then implement methods and techniques described above to access and render visual content—corresponding to the newly-placed physical object—on the main display. The game console can then access a remote or local copy of a namespace linked to the physical object's unique ID and associated with the current game, as described above.

### 7. Virtual Object Manipulation

Block S142 of the method S100 recites generating a first graphical representation of the first virtual object according to the characteristic defined in the first namespace; and Block S140 of the method S100 recites rendering the first graphical representation of the first virtual object on a first region of the main display coinciding with the first position. Generally, in Blocks S140 and S142, the game console updates the virtual game environment of the game currently in play at the game console with a virtual object according to placement of an associated physical object on the game console. For example, once the game console accesses a namespace for a physical object placed on the game console, the game console can: extract a graphical representation of a virtual object linked to the physical object from the namespace; generate a graphical representation of the virtual object according to characteristics defined in the namespace; or retrieve a graphical representation stored within a game file for the current game and linked to the physical object's unique ID via the namespace in Block S142. The game console can then render the graphical representation of the virtual object on a region of the main display coinciding with the detected location of the physical object in Block S140.

In Block S140, the game console can also manipulate the virtual object within the game environment—according to virtual interaction rules defined in the particular namespace and/or by the game—in response to interactions between the physical object and the game console. For example, when a first physical object is placed on the main display, the game console can: render its corresponding first virtual object on the main display, such as according to the method S100; apply a virtual power available to the first virtual object to another virtual object within the virtual game environment to modify (e.g., destroy, move, augment) the other virtual object; or change the virtual game environment according to the first virtual object represented by the physical object and the physical object's location on the game console, such as by adding virtual snow to the virtual game environment when a physical snow object is placed on the main display; etc. Similarly, as the physical object is moved across the main display, the game console can move its corresponding virtual object within the virtual game environment.

In an example of this implementation, the physical object can contain an ID linked to a namespace—corresponding to the game in play—specifying an environment-type virtual object, such as a virtual tree, virtual snow, or a virtual body of water, and the physical object can define a physical form representative of this environment-type virtual object. The game console can thus enable a player to populate a virtual game environment rendered on the main display with instances of the environment-type virtual object by “stamping” the physical object across the display. In this example, when a physical “tree” object (or other physical object linked to a virtual tree object via a namespace) is placed on the main display, the game console can: retrieve a static or animated graphical representation of a tree (e.g., a static digital cartoon or digital animation of a plan or elevation view of a tree) in Block S130; render the graphical representation of the tree at a position on the main display where the physical tree object was placed in Block S140; and preserve the graphical representation of the tree at this position on the main display even after the physical tree object is removed from the main display in Block S150, as shown in FIG. 1. (For the graphical representation of the tree that is animated, the game console can continue to animate the graphical representation even after the physical object is removed from the main display.) Furthermore, as the same physical tree object is stamped across multiple locations on the main display, the game console can render multiple instances of the graphical representation of the tree within the virtual game environment at positions coinciding with each discrete contact location of the physical tree object.

In this example, when a physical “snow” object is later placed on the main display during the same gameplay, the game console can similarly download a static or animated graphical representation of snow—linked to the physical snow object via a corresponding namespace—such as a digital cartoon of snowflakes, rules for patterning digital snowflake cartoons over other graphical resources rendered on the display, a hierarchy for applicability of digital snowflake cartoons over other graphical resources, and rules for modifying other graphical resources based on the presence of a digital snowflake cartoon within the graphical environment. Thus, in response to placement of the physical snow object on the main display, the game console can pattern instances of the digital snowflake cartoon over other graphical resources (e.g., trees and terrain) rendered on the main display and ranked below the digital snowflake cartoon in the hierarchy. The game console can also modify other graphical resources rendered on the display based on application of the physical snow object onto the main display, such as by replacing an animated graphical resource representing a flowing body of water with a static graphical resource representing a frozen body of water within the virtual game environment. The game console can preserve this state of the virtual game environment—including modifications to other graphical resources rendered on the display—after the physical snow object is removed from the main display in Block S150.

In this variation, when a physical object containing an ID assigned to a character class for a current gameplay is placed on the main display, the game console can retrieve a corresponding graphical character resource associated with the physical character object's unique ID, such as: an animated cape for a physical character object representing (or linked to) a superhero; animated pixie dust for a physical character object representing a fairy; animated lighting bolts for a physical character object representing a wizard (shown in FIG. 1); or animated fire for a physical character object representing a dragon (shown in FIG. 2) in Block S130. The game console can then render the (static or animated) graphical resource on the main display at a region coinciding with (e.g., centered on) the detected location of (the center of) the physical character object in Block S140.

Furthermore, upon placement of the physical object on the main display and insertion of the corresponding graphical resource into the virtual game environment, the game console can initiate interactions with other virtual resources within the virtual game environment, such as to show the graphical resource engaging (e.g., fighting) another character in the virtual game environment, chopping down a virtual tree object, laying virtual train tracks, or performing another virtual action associated with the graphical resource represented by the physical character object. When removal of the physical character object from the main display is later detected, the game console can remove the graphical resource from this region of the display but may preserve results of interactions between the graphical resource and other virtual resources within the virtual game environment. Similarly, when the physical character object is moved to another position on the main display, the main console can virtually move the corresponding graphical resource within the virtual game environment and render this updated virtual game environment on the main display accordingly.

Therefore, in response to placement of the physical object at a particular position on the game console, the game console can: render an animation of a virtual action allocated to the corresponding virtual object on the main display proximal (e.g., centered under) the physical object; and update virtual assets—within the instance of the electronic game—rendered on the main display to reflect this virtual action. The game console can also: detect an orientation of the physical object on the game console, as described above; orient the animation rendered on the main display according to the orientation of the physical object placed on the game console; and update virtual assets within the instance of the first electronic game to reflect the virtual action extending along a virtual path corresponding to the orientation of the physical object on the game console.

In this variation, the game console can execute Block S152, which recites, based on the class of the physical object, removing the virtual representation of the physical object from the region of the display in response to removal of the physical object from a surface of the game console. For example, after retrieving a namespace—in a set of namespaces linked to the physical object's unique ID—linking the physical object to a custom virtual character in Block S130, the game console can: generate a graphical representation of the custom virtual character based on object definitions and other data contained in the namespace and/or defined in the game; enter the custom virtual character into a virtual game environment for the game when the physical object is placed on the game console in Block S142; and then render the graphical representation of the custom virtual character within the virtual game environment on the main display in Block S140. In this example, once the game console detects that the physical object has been removed from the game console, the game console can remove the physical object from the virtual game environment and update the virtual game environment rendered on the display accordingly in Block S152.

However, the game console can implement any other method or technique to introduce a virtual object into a virtual game environment and to modify the virtual game environment according to an action or command associated with the virtual object when a physical object linked to the virtual object is placed on or moved across the game console. The game console and the remote server can also implement these methods and techniques to handle multiple physical objects placed on and/or moving across the game console substantially simultaneously during an instance of a game at the game console.

### 8. Audio

For a physical object linked to an audio resource within a game, the main console can also replay audio content when the physical object is placed on the main display. In particular, in response to detection of a physical object on a surface of the game console and receipt of an ID from the physical object, the game console can determine a context in which the physical object was placed on the game console (e.g., a defensive move, an offensive move, a modification to a virtual environmental condition, etc.), and select a particular audio resource to replay in response to placement of the physical object on the main display based on the context of the play. For example, when a physical dragon object is placed on the main display, identified, and confirmed as associated with a particular user at the game console; the game console can play a first audio resource representing a dragon flying onto the game console, such as through an integrated speaker; and the main display can render a digital cartoon of fire moving from a position on the display associated with the particular user toward a region on the main display coinciding with the detected location of the physical dragon object. In this example, when the physical dragon object is removed from the game console: the game console can play a second audio resource representing a dragon taking off from the game console; and the main display can render the digital cartoon of fire moving from the region on the main display coinciding with the previous detected location of the physical dragon object toward the position on the display associated with the particular user.

Therefore, in this variation, the game console can: access an audio clip related to a virtual object linked to a physical object placed on the game console; and replay the audio clip and render a graphical representation of the virtual object on the main display of the game console substantially simultaneously.

### 9. Physical Object and Virtual Object Permissions

In one variation, the game console and/or the remote server can confirm use of the physical object within the current game and/or by a particular player (i.e., user). For example, when a physical object is first placed on the main display during a new instance of a game at the game console: the game console can return the physical object's unique ID, an ID of the game, and/or an ID of the game console to a remote server; and the remote server can then compare the ID of the game to a permission namespace assigned to the physical object's unique ID to confirm that the physical object has been authorized for play in the game. The remote server can also compare the ID of the game console to a user account associated with the physical object's unique ID to confirm that the physical object's owner has authorized the physical object for play at the game console.

In another example, when a physical object is placed on the main display during a player's turn during a gameplay, the game console can compare an ID of the player with an ownership ID of a user account linked to the physical object's unique ID; the game console can confirm the gameplay and update the virtual game environment accordingly if the player ID and the ownership ID match. However, in this example, if the player ID and the ownership ID do not match, the game console and/or the remote server can transmit a notification to the user account linked to the physical object, prompt the current owner to confirm use of the physical object by the player, and reject the play with the physical object or enter the play into the virtual game environment according to a response subsequently entered by the current owner's response to this inquiry.

### 10. Fast Namespace Lookup

In one variation, when the game console initiates a gameplay for a selected game, the game console can: download—from a remote server—namespaces for all physical objects previously used at the game console, whitelisted for the game, or otherwise associated with the selected game specifically or with the game console; and store these data locally at the game console for quick lookup when such physical objects are placed on the main display. Similarly, when a player enters the game, the game console can: download—from a remote server—namespaces for all physical objects currently owned by the player and linked to or whitelisted for the game; and store these namespaces locally at the game console for quick lookup as physical objects are placed over the main display during the current game or current session at the game console.

### 11. Updated Namespaces

Block S164 of the method S100 recites, in response to a gameplay action during the instance of the first electronic game, modifying the characteristic of the first virtual object defined in the first namespace in the first user account. (Block S164 can similarly recite: recording a sequence of gameplay actions involving the custom virtual character; modifying a characteristic of the virtual object defined in the namespace according to the sequence of gameplay actions; and updating the graphical representation rendered on the main display according to the characteristic.) Generally, in Block S164, the game console: records gameplay actions executed by, directed toward, or otherwise involving a virtual object linked to a namespace of a physical object; updates the virtual object within the virtual game environment according to these actions, such as by changing visual characteristics of the virtual object or a “health” of the virtual object; and updates this namespace accordingly.

In one implementation, the game console: records characterizations of plays made with physical objects and their corresponding virtual objects throughout a gameplay; and writes these data to corresponding namespaces, such as in real-time or asynchronously once the gameplay is completed. For example, the game console and the remote server can cooperate to maintain a current log of: players who have used the physical object and its corresponding virtual object, a health score of the virtual object; a level of the virtual object within the game; visual and/or audio customization values of the virtual object; virtual skills and/or powers available to the virtual object; etc. that may be altered during a gameplay and preserved for a subsequent gameplay. In another example, throughout the current game or gaming session at the game console, the game console: updates a local copy of a namespace according to gameplay actions involving a corresponding physical object or virtual object; and then returns the updated namespace to the remote server regularly (e.g., once per minutes), upon conclusion of the current game, or upon conclusion of the current session at the game console.

### 12. Upgrading a Virtual Object

Block S164 can additionally or alternatively include: augmenting the virtual object with a new gameplay function during the instance of the game; updating the graphical representation of the virtual object rendered on the main display according to the gameplay function; and writing permission for the gameplay function to a corresponding namespace—linked to the physical object—stored in a remote database. Generally, in this variation, the game console, the remote server, and/or the native object portal application executing on a separate computing device can enable a user (e.g., the physical object's owner) to upgrade or modify a virtual object linked to the physical object.

For example, as described below, the user can access a virtual object through an instance of the native object portal application executing on his smartphone by tapping the corresponding physical object on the smartphone or on a peripheral reader (e.g., a RFID reader) coupled to the user's smartphone. The user can then navigate through a virtual upgrade store within the native object portal application to purchase a virtual upgrade for the virtual object, such as health, a virtual weapon, or virtual body armor. In another example, after logging a physical object into the native object portal application executing on his smartphone, as described above, the user can tap an ID-enabled upgrade card or other physical upgrade widget onto his smartphone or connected device. The instance of the native object portal application can then: pass a unique ID received from the physical upgrade widget to the remote server to retrieve use history of the physical upgrade card (e.g., whether the physical object has already been used to upgrade another virtual object), a type and magnitude of a virtual upgrade linked to the physical upgrade widget, and/or an applicability of the virtual upgrade to the virtual object, etc.; and write upgrade values from the physical upgrade widget's namespace to the namespace defining the virtual object and linked to the physical object's unique ID.

In another example, the native object portal application can interface with the user to select or change: a face; eyes; a nose; a hat; clothing; shoes; a weapon; a shield; accessories; a color; or any other visual characteristic of the virtual object linked to the physical object's unique ID. The native object portal application can write these selections or changes to the namespace defining the virtual object and linked to the physical object's unique ID such that the virtual object is rendered with these selections or changes each time the physical object is subsequently placed on a game console and until the virtual object is again modified through the native object portal application or through gameplay actions at a game console. Therefore, the native object portal application can interface with a user—during or outside of a game at a game console—to upgrade or modify a virtual object linked to a physical object's unique ID via a virtual store or via other physical objects defining virtual upgrade values for the virtual object.

The game console can implement similar methods and techniques to upgrade a virtual object linked to a physical object before or during an instance of a game in process at the game console. However, the game console, the remote server, and/or the native object portal application can implement any other methods and techniques to virtually upgrade a virtual object when a physical or virtual upgrade object is connected to the virtual object, such as by storing these upgrade values in the virtual object's namespace for recall during when the physical object is later placed on a game console during an instance of the corresponding game.

### 13. Linking a Physical Object to a Virtual Object

As shown in FIG. 4, one variation of the method S100 includes: Block S120, which recites rendering a prompt on a main display of the game console to link a physical gamepiece to a virtual object within the first electronic game; Block S122, which recites confirming permission to link the physical object to the virtual object based on the unique identifier and a characteristic of the virtual object; and Block S124, which recites linking the unique identifier to the virtual object. Generally, in Blocks S120, S122, and S124, the game console can temporarily or permanently link a physical object's unique ID to a new namespace for a virtual object previously unrelated to the physical object, such as if characteristics of the virtual object meet rules specified in a blacklist or whitelist associated with the physical object.

In one example, a group of users select a game specifying control of multiple virtual objects within a virtual game environment—rendered on the main display of the game console—through manipulation of corresponding physical objects over the main display. However, in this implementation, if no physical object available at the game console is associated with a particular virtual object specified in the game, the game console can prompt the users to affiliate an alternate physical object—not otherwise associated with a virtual object specified in the game—with the particular virtual object. The game console can therefore create a new temporary local namespace (or can cooperate with the remote server to create a temporary remote namespace) linking the alternate physical object to the particular virtual object in order to complete a set of physical objects needed to play the selected game at the game console and in order to enable the group of users to control the particular virtual object within the virtual game environment by physically interfacing the alternate physical object with the game console.

In this example, the game console can: access a list of virtual object types specified in a game selected for play at the game console; access a list of physical objects associated with virtual object types in the list of virtual objects and previously identified at the game console; and then identify a particular virtual object type in the list of virtual object types not represented by a physical object in the list of physical objects. The game console can then retrieve a static image, an animation, or another visual media for the particular virtual object type, such as from a namespace associated with the selected game and stored locally on the game console or remotely on a computer network, and can render this visual media on the main display along with a visual prompt to associate an ID-enabled physical object with the visual media. In particular, in this example, the game console can prompt a user to place an ID-enabled physical object—not otherwise linked to a namespace defining a virtual object or virtual object type specified in the selected game—on a graphical representation of the virtual object rendered on the main display on the game console. The game console can then detect placement of a physical object over the main display at a location coinciding within the graphical representation of the virtual object in Block S112 and scan a corresponding wireless receiver for an ID from the physical object in Block S114. Thus, in response to receipt of an ID from the physical object in contact with the game console, the game console can associate the ID of the physical object with the particular virtual object type. In particular, the game console can create a temporary namespace—linking the ID of the physical object to a virtual object of the particular virtual object type—that persists throughout the instance of the game or through a current session at the game console.

In a similar implementation, when a new instance of a game is selected by players at a game console, the game console can: initialize a virtual game environment for the instance of the game; render graphical representations of virtual objects required for play of the game on the main display of the game console; and prompt players to link ID-enabled physical objects with each of these virtual objects by placing these physical objects on the main display over graphical representations of these virtual objects in Block S120. As players place physical objects over these graphical representations, the game console can implement methods and techniques described above to identify each physical object in Block S110. For a first physical object placed over a graphical representation of a first virtual object, the game console can query the remote server for a namespace linked to the first physical object's unique ID and linked to the game's ID and/or to an ID of the first virtual object in Block S130; upon receipt of a namespace defining an existing connection between the first physical object and the first virtual object, the game console can confirm this association between the first physical object and first virtual object for the duration of the instance of the game or current session at the game console. However, if the remote server fails to identify such a namespace for the first physical object's unique ID, the remote server can instead return a whitelist, blacklist, or namespace containing permissions for linking the physical object to other virtual objects to the game console. Upon receipt of these data, the game console can: confirm that the first physical object is permitted to be linked to the first virtual object, such as based on a type or characteristic of the first virtual object; retrieve a copy of a predefined namespace for the first virtual object; and then write the first physical object's unique ID to this predefined namespace. For example, the game console can: cooperate with the remote server to retrieve a list of characteristics of virtual objects excluded from affiliation with the first physical object in Block S122; and then confirm permission to link the first physical object to the first virtual object if the list of characteristics excludes all stored characteristics of the first virtual object.

However, in the foregoing implementation, if these data indicate that the first physical object is not permitted to be linked to the first virtual object, the physical object can reject the first physical object in Block S126 and prompt players at the game console to place an alternate physical object on the graphical representation of the first virtual object, as shown in FIG. 4. For example, in response to absence of a namespace—in a set of namespaces assigned to the first physical object's unique identifier in the first user account—associated with a game recently initiated at the game console, the game console can retrieve a list of characteristics of virtual objects excluded from affiliation with the first physical object based on its unique identifier in Block S122. In this example, if the list of characteristics includes a characteristic of the first virtual object that a player has attempted to link to the first physical object, the game console can: reject a link between the first physical object and the first virtual object in Block S126; and render a new prompt on the main display to link an alternative physical gamepiece to the first virtual object in Block S120. In this example, if the first physical object is physically representative of a super hero character and is associated by default with a namespace for a superhero and a blacklist preventing association with a virtual villain character, a virtual resource, or a virtual object from a particular publisher, the game console can reject association between the first physical object and the first virtual object that represents a virtual villain character, a virtual resource, or a virtual object or virtual character in a game publisher by the particular publisher.

The game console can repeat these processes for each other virtual object rendered on the game console's main display and for each other physical object placed on the game console at the start of the game.

Once a physical object is thus linked to a new virtual object (e.g., once the physical object's unique ID is linked to a copy of a preexisting namespace defining a virtual object previously unaffiliated with the physical object), the game console can implement methods and techniques described above to manipulate the new virtual object within its virtual game environment on the game console according to physical interactions between the physical object and the game console during an instance of a game. For example, once a physical object is temporarily linked to a new virtual object, the game console can: detect placement of the physical object at a second position over the main display in Block S110; and render a graphical representation of the virtual object on a second region of the main display coinciding with the second position in Block S140.

Throughout an instance of a game in play at the game console, the game console can modify a temporary namespace, such as by: modifying the visual appearance of the virtual object corresponding to the physical object's unique ID as the virtual object ‘levels-up,’ gains or loses health, powers, skills, etc., or is altered by one or more users during gameplay; by modifying the interactions between the virtual object corresponding to the physical object's unique ID and other virtual objects within the virtual game environment as the virtual object ‘levels-up,’ gains or loses health, powers, skills, etc. during gameplay; and/or by modifying virtual actions performed by the corresponding virtual object in response to manipulation of the physical object on and across the game console; etc.

### 14. Temporary and Persistent Namespaces

Following completion of an instance of a game in which a namespace for a virtual object is temporarily linked to a physical object, the game console can discard (e.g., delete) the temporary namespace upon conclusion of the instance of the game or upon conclusion of the current session at the game console. In particular, upon completion of the instance of the game, the game console can clear the temporary namespace and dissociate the temporary namespace from the physical object's unique ID.

Similarly, upon completion of the instance of the game, the game console can reset the temporary namespace to an initial condition and preserve the association between the temporary namespace and the physical object's unique ID, such as until the game console is shutdown or until a request to link an alternate physical object to the virtual object or to the virtual object type is received. The game console can thus enable players at the game console to play additional instances of the game without repeating the process described above to link a virtual object to the same physical object. However, the game console can discard the temporary namespace or otherwise dissociate the temporary namespace from the physical object's unique ID once the game console is shut down or once an alternative game is selected for play at the game console. Similarly, as described below, the game console can also preserve a link between the physical object and the temporary namespace for a new virtual object in a new game for a threshold number of (e.g., three) instances of the new game before discarding this link between the physical object and the new virtual object, thereby enabling players at the game console to trial a new game with existing ID-enabled physical objects before purchasing an electronic copy of the game and ordering corresponding physical objects.

Alternatively, once the physical object's unique ID is linked to a copy of a preexisting namespace defining a virtual object previously unaffiliated with the physical object, the game console can upload this namespace to the remote server for storage and reuse when the physical object is introduced to the same or other game console during a later instance of the same game. For example, the game console can permanently write this namespace for the new virtual object to a user account associated with the physical object in Block S124. Thus, when a new instance of the same game is initiated at the same or other game console and the physical object is placed on the game console at the start of this game, the game console can retrieve this persistent namespace from the remote server, link the physical object to the virtual object according to this persistent namespace, and then control the virtual object within the virtual game environment according to physical interactions between the physical object and the game console, as described above.

### 15. New Electronic Game

In one variation, the game console (and/or a native object portal application executing on the player's smartphone) hosts a game store at which players at the game console may select, trial, and/or purchase new games. When a new game is trialed or purchased at the game console, physical objects specific to this game and linked to virtual objects within a virtual game environment defined by this game may not be immediately available. Therefore, the game console (or the native object portal application) can implement the foregoing methods and techniques to temporarily link new virtual objects in the new game to physical objects that the players already have on hand (i.e., physical objects linked by default to other virtual objects in other games). For example, the game console can: trial a new game up to three times before requiring purchase of an electronic copy of the new game; link unique IDs of physical objects on hand at the game console to namespaces of virtual objects in the new game, as described above; and preserve these links for up to three instances of the new game.

When preparing to complete purchase of a copy of the new game following a trial, the game console can prompt a player to select purchase of only the electronic copy of the new game or both the electronic copy of the new game and a set of ID-enabled physical objects unique to the new game. If the player(s) selects the former purchase option, the game console can upload namespaces—generated previously to link physical objects to virtual objects in the new game during a trial—to the remote server for permanent storage; the game console can later retrieve and implement these namespaces when another instance of the new game is initiated with the same physical objects. However, if the player(s) selects the latter purchase option, the game console can upload these namespaces to the remote server for temporary storage until the set of physical objects specific to the new game are received by these players; once these new physical objects are received, the remote server can discard these temporary namespaces.

Furthermore, if a temporary namespace for a particular virtual object in the new game is linked to an existing physical object and updated with dynamic content based on gameplay actions at the game console, as described above, the game console can port data—such as level, customization settings, history, activity, ownership, etc.—from this temporary namespace to a permanent namespace for a new physical object linked to the particular virtual object once the new physical object is received by its new owner. Similarly, once the new physical object is received by its new owner and placed on the game console (or on another computing device executing the native object portal application) for setup, the game console and/or the remote server can reassign the namespace from the existing physical object's unique ID to the new physical object's unique ID.

### 16. Upgrading and Replacing a Physical Object

The game console, the remote server, and/or the native object portal application can also implement the foregoing methods and techniques to enable a user to upgrade or replace a physical object, such as to replace a physical object if lost, to replace a plastic physical object with an upgraded (e.g., solid pewter) physical object, or to link a new physical object of a form more representative of a now-upgraded virtual object to a namespace associated with the now-upgraded virtual object. For example, the game console, the remote server, and/or the native object portal application can reassign an existing namespace to an ID of an alternate physical object, such as by dissociating an ID of one physical object from a namespace and reassigning the namespace to an ID of another physical object or by copying static and/or dynamic data from a first namespace associated with a first physical object ID to a second namespace associated with a second physical object ID according to methods and techniques described above.

In one example, if a user loses or damages a first ID-enabled physical object linked to a first namespace defining a first virtual object in a first game, the user can: assemble a custom ID-enabled physical object, such as by placing an RFID tag onto an action figure or by placing the action figure on an ID-enabled action figure base; scan the custom ID-enabled physical object into his smartphone; and then transfer the first namespace from the first physical object to the custom physical object through the native object portal application executing on his smartphone. Therefore, when the user later places this custom physical object onto a game console executing an instance of the first game, the game console can retrieve the first namespace and manipulate a first virtual object within a virtual game environment of the first game according to interactions between the custom physical object—rather than the first physical object—and the game console. In this example, the remote server can store this new association between the custom physical object and the first namespace in a persistent namespace, such as until the user orders a replacement physical object and implements a similar process to reassign the first namespace to a replacement physical object's unique ID.

### 17. New Virtual Object

In another variation shown in FIG. 5, the game console (or native object portal application or remote server) can host transfer of a virtual object (e.g., a character) from a first user to a second user by reassigning a namespace from a unique ID of a first physical object owned by (e.g., linked to a user account of) the first user to a unique ID of a second physical object owned by the second user. For example, the remote server can automatically remove the first physical object's unique ID from the namespace when the second user purchases, trades, or wins the virtual object from the first user; and writes a unique ID of a second physical object owned by the second user to the namespace once the second physical object is selected. For example, an instance of the native object portal application executing on the second user's computing device can prompt the user to select a virtual representation of a physical object linked to the second user's account, and the remote server can link a known ID of the selected physical object to the namespace. In another example, when the second user purchases, trades, or wins the virtual object from the first user at a game console, the game console can: render a graphical representation of the virtual object on the game console's main display); prompt the second user to place a second physical object on the game console over the graphical representation of the virtual object; confirm that the second physical object is available for linking to the virtual object; and then transfer the namespace for the virtual object to a unique ID read from this second physical object placed on the game console, such as according to methods and techniques described above.

Therefore, in response to a gameplay action—during an instance of the electronic game—between a first user and a second user that results in transfer of ownership of a first virtual object defined by a first namespace from the first user's account to the second user's account, the game console can: port the first namespace from the first user's account to the second user's account; and link the first namespace to a second unique ID of a second physical object affiliated with second user's account (and selected by the second user during or upon conclusion of the instance of the game).

Furthermore, in the foregoing variations and implementations, the game console, remote server, and/or native object portal application can link a single unique ID of one physical object with multiple unique namespaces for different virtual objects across different games played at one or more game consoles over time. For example and as described above, a unique ID of a single physical object can be: linked by default (e.g., by a manufacturer) to a first persistent namespace defining a first virtual character aesthetically similar to the physical object and associated with a first game; linked by its owner to a temporary namespace defining a virtual environmental object (e.g., a tree, a settlement) associated with a second game when trialing the second game; and linked by another player to a temporary namespace defining a virtual object associated with a third game when the other player plays an instance of the third game at the user's game console but does not have access to her own physical objects for the third game; etc.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for manipulating virtual objects within a virtual game environment, the method comprising:
at a game console, initializing a first virtual game environment in an instance of a first electronic game;
rendering a prompt on a main display of the game console to link a physical gamepiece to a virtual object within the first electronic game;
in response to placement of a physical object over the main display of the game console at a first time:
accessing a unique identifier from the physical object;
confirming permission to link the physical object to the virtual object based on the unique identifier and a characteristic of the virtual object; and
linking the unique identifier to the virtual object;
at a second time:
detecting placement of the physical object at a second position over the main display; and
rendering a graphical representation of the virtual object on a second region of the main display coinciding with the second position.

2. The method of claim 1, wherein detecting placement of the physical object at the second position over the main display comprises:
during the instance of the first electronic game in play at the game console, sampling a touch sensor coupled to the main display within the game console;
in response to detection of a physical gamepiece at the second position over the touch sensor at the second time, sampling a second wireless receiver, in an array of wireless receivers arranged in the game console, coinciding with the second position; and
detecting placement of the physical object at the second position in response to receipt of the unique ID from the physical object within a threshold duration following the second time.

3. The method of claim 1, further comprising removing a link between the unique identifier and the virtual object in response to conclusion of the instance of the first electronic game.

4. The method of claim 1:
wherein rendering the prompt on the main display to link a physical gamepiece to the virtual object within the first electronic game comprises rendering the graphical representation of the virtual object on a first region of the main display; and
wherein linking the unique identifier to the virtual object comprises linking the unique identifier to the virtual object in response to detection of the physical object at a first position over the main display coinciding with the first region and in response to confirmation of permission to link the physical object to the virtual object.

5. The method of claim 1, wherein confirming permission to link the physical object to the virtual object comprises:
retrieving a list of characteristics of virtual objects excluded from affiliation with the physical object; and
in response to the list of characteristics excluding a characteristic of the first virtual object, confirming permission to link the physical object to the virtual object.

6. The method of claim 5, further comprising:
at a third time, rendering a second virtual game environment of a second electronic game on the main display;
rendering a prompt on the main display of the game console to link a physical gamepiece to a second virtual object within the second electronic game;
in response to placement of the physical object over the main display of the game console, accessing the unique identifier from the physical object;
in response to the list of characteristics comprising a characteristic of the second virtual object:
rejecting a link between the physical object and the second virtual object; and
rendering a prompt on the main display to link an alternative physical gamepiece to the second virtual object.

7. A method for manipulating virtual objects within a virtual game environment, the method comprising:
linking a unique identifier encoded into a physical object to a first user account of a first user;
associating a first namespace with the unique identifier, the first namespace defining a characteristic of a first virtual object within a first electronic game;
at a game console:
initializing an instance of the first electronic game;
during the instance of the first electronic game in play at the game console, detecting presence of the physical object at a first position on the game console based on receipt of the unique identifier wirelessly broadcast from the physical object;
retrieving the first namespace;
generating a first graphical representation of the first virtual object according to the characteristic defined in the first namespace; and
rendering the first graphical representation of the first virtual object on a first region of the main display coinciding with the first position; and
in response to a gameplay action during the instance of the first electronic game, modifying the characteristic of the first virtual object defined in the first namespace in the first user account.

8. The method of claim 7, further comprising, in response to a gameplay action during the instance of the first electronic game between the first user and a second user associated with a second user account resulting in transfer of ownership of the first virtual object from the first user account to the second user account:
porting the first namespace to the second user account;
linking the first namespace to a second unique identifier of a second physical object affiliated with second user account.

9. The method of claim 7, wherein modifying the characteristic of the first virtual object defined in the first namespace comprises:
augmenting the first virtual object with a new gameplay function during the instance of the first game;
updating the first graphical representation of the first virtual object rendered on the main display according to the gameplay function; and
writing permission for the gameplay function to the first namespace stored in a remote database.

10. The method of claim 7, further comprising, during an instance of a second electronic game at the game console:
rendering a prompt on the main display of the game console to link a physical gamepiece to a second virtual object within the second electronic game;
in response to placement of the physical object over the main display of the game console at a first time:
accessing the unique identifier from the physical object;
confirming permission to link the physical object to the second virtual object based on the unique identifier and a second characteristic of the second virtual object; and
writing a second namespace for the second virtual object to the first user account, the second namespace linked to the unique identifier;
at a second time:
detecting placement of the physical object at a second position over the main display; and
rendering a second graphical representation of the second virtual object on a second region of the main display coinciding with the second position.

11. The method of claim 10:
wherein retrieving the first namespace comprises, during the instance of the first electronic game, retrieving the first namespace labeling the first virtual object as a virtual avatar;
further comprising, during the instance of the first electronic game, removing the first graphical representation of the virtual avatar from the first region of the main display following removal of the physical object from contact with the game console;
wherein writing the second namespace for the second virtual object to the first user account comprises linking the unique identifier to the second namespace labeling the second virtual object as a virtual environment object in the second electronic game; and
further comprising, during the instance of the second electronic game, preserving the second graphical representation of the virtual environment object rendered on the region of the main display following removal of the physical object from contact with the game console.

12. The method of claim 1, further comprising:
at a second time, initializing an instance of a second electronic game;
rendering a prompt on the main display of the game console to link a physical gamepiece to a second virtual object within the second electronic game;
in response to placement of the physical object over the main display of the game console, accessing the unique identifier from the physical object;
in response to absence of a namespace, in a set of namespaces assigned to the unique identifier in the first user account, associated with the second electronic game, retrieving a list of characteristics of virtual objects excluded from affiliation with the physical object based on the unique identifier; and
in response to the list of characteristics comprising a characteristic of the second virtual object:
rejecting a link between the physical object and the second virtual object; and
rendering a prompt on the main display to link an alternative physical gamepiece to the second virtual object.

13. The method of claim 7, wherein detecting placement of the physical object at the first position on the game console comprises:
during the instance of the first electronic game in play at the game console, sampling a touch sensor coupled to the main display within the game console;
in response to detection of a physical gamepiece at the second position over the touch sensor at the second time, sampling a second wireless receiver, in an array of wireless receivers arranged in the game console, coinciding with the second position; and
detecting placement of the physical object at the second position in response to receipt of the unique ID from the physical object within a threshold duration following the second time.

14. A method for manipulating first virtual objects within a first virtual game environment, the method comprising:
during an instance of a first electronic game in play at a game console, sampling a touch sensor coupled to a main display within the game console;
in response to detection of a physical object at a first position over the touch sensor, sampling a first wireless receiver, in an array of wireless receivers arranged in the game console, coinciding with the first position;
accessing a first graphical representation of a first virtual object associated with the first electronic game and linked to a unique identifier downloaded from the physical object via the wireless receiver; and
rendering the first graphical representation of the first virtual object on a first region of the main display coinciding with the first position.

15. The method of claim 14:
further comprising, at the game console, initializing a first virtual game environment in the instance of the first electronic game;
wherein accessing the first graphical representation of the first virtual object comprises:
retrieving from a remote database a first namespace, in a set of namespaces linked to the unique identifier, associated with the first electronic game;
generating the first graphical representation of the first virtual object locally at the game console based on object data contained in the first namespace, the first virtual object comprising a custom virtual character associated with the physical object; and
entering the custom virtual character into the first virtual game environment; and
wherein rendering the first graphical representation of the first virtual object on the first region of the main display comprises rendering the first graphical representation of the custom virtual character within the virtual game environment on the main display.

16. The method of claim 15, further comprising, during the instance of the first electronic game at the game console:
recording a sequence of gameplay actions involving the custom virtual character;
modifying a characteristic of the first virtual object defined in the first namespace according to the sequence of gameplay actions; and
updating the first graphical representation rendered on the main display according to the characteristic.

17. The method of claim 15, further comprising:
initializing a second virtual game environment in an instance of a second electronic game at the game console;
during the instance of the second electronic game, receiving the unique identifier from the physical object placed at a second position over the touch sensor;
retrieving from the remote database a second namespace, in the set of namespaces linked to the unique identifier, associated with the second electronic game;
linking the physical object to a second virtual object within the second electronic game according to the second namespace; and
rendering a generic graphical representation of the second virtual object on a second region of the main display coinciding with the second position.

18. The method of claim 14, wherein rendering the first graphical representation of the first virtual object on the main display comprises, in response to placement of the physical object on the game console at the first position:
rendering an animation of a virtual action allocated to the first virtual object on the main display proximal the first position of the physical object; and
updating virtual assets within the instance of the first electronic game rendered on the main display to reflect the virtual action.

19. The method of claim 14:
further comprising:
at a first time, rendering a first virtual game environment of the first electronic game on the main display;
rendering the first graphical representation of the first virtual object at a default location within the first virtual game environment on the main display;
rendering a prompt on the main display to link a physical gamepiece to the first virtual object;
in response to receipt of the unique identifier from the physical object, retrieving from a remote database a first namespace, in a set of namespaces linked to the unique identifier received from the physical object, associated with the first electronic game; and
in response to the first namespace specifying a characteristic represented by the first virtual object, confirming a link between the physical object and the first virtual object within the first virtual game environment for a duration of the instance of the first electronic game; and
wherein rendering the first graphical representation of the first virtual object on the first region of the main display coinciding with the first position comprises, at a second time succeeding the first time, rendering the first graphical representation of the first virtual object on the first region of the main display coinciding with the first position according to the link between the physical object and the first virtual object in response to detection of the physical object at the first position on the game console.

20. The method of claim 19, further comprising:
at a second time, rendering a second virtual game environment of a second electronic game on the main display;
rendering a second graphical representation of a second virtual object at a default location within the second virtual game environment on the main display;
rendering a prompt on the main display to link a physical gamepiece to the second virtual object;
downloading the unique identifier from the physical object in response to placement of the physical object on the game console;
in response to omission of a second namespace, in the set of namespaces, associated with the second electronic game, retrieving an object class exclusion list for the unique identifier; and
in response to the object class exclusion list specifying a characteristic of the second virtual object:
rejecting a link between the physical object and the second virtual object; and
rendering a prompt on the main display to link an alternative physical gamepiece to the second virtual object.
